(19) United States
(12) Patent Application Publication
(10) Pub. No.: US 2023/0338221 A1
(43) Pub. Date: Oct. 26, 2023

(54) SPINE COMPRESSION PREVENTION AND DECOMPRESSION CHAIR

(71) Applicants: Raj Shekhar Roychoudhury, Bloomfield Hills, MI (US); Bhup Thakur, West Bloomfield, MI (US)

(72) Inventors: Raj Shekhar Roychoudhury, Bloomfield Hills, MI (US); Bhup Thakur, West Bloomfield, MI (US)

(21) Appl. No.: 17/725,831

(22) Filed: Apr. 21, 2022

(51) Int. Cl. A61H 1/02

(52) U.S. Cl. CPC A61H 1/0292; A61H 2201/0149; A61H 2201/1623; A61H 2201/164; A61H 2201/0192; A61H 2203/0425

(57) ABSTRACT

A chair apparatus is provided. The chair includes a seat, a back rest, a leg rest, and a vertical front support. The leg rest is connected to the seat. The vertical front support rotatably supports the leg rest and seat at or near the junction of the seat and leg rest. The seat is movable from a first position that is in at least close proximity to the back rest to a second position in which a rear portion of the seat is moved down and away from the back rest to a sufficient distance that removes sufficient upward force on a spine of a user to enable spine decompression when the user sits on the seat.

### FIELD

This disclosure generally relates to physical therapy for the prevention and repair of human back pain episodes, and more specifically to the reduction of reaction forces generated by the buttock while sitting in a regular flat chair. The compressive force applied on the spine while sitting on a regular chair over the years is one of the leading causes of human back pain.

### BACKGROUND

One of the main causes of back pain is the constant compression of the spine when sitting in a chair over long periods of time for many years along with bad sitting habits such as slouching. This compressive force, applied over the years, leads to stiff muscles, limited blood circulation thus causing long term spinal bone and cartilage damage leading to spine stenosis causing back pain. The pain gets worst over time and impairs a person's ability to function. Treatments offered are exercise, physical therapy, steroid injection and sometimes surgery.

Hence there is a need to eliminate this compressive load on the spine while sitting in a chair, thereby preventing long term injury and subsequently resulting in back pain.

Spine decompression chairs and tables have been developed for repairing back pain. But none of these chairs are meant for regular sitting use, for elimination of the compressive forces to the spine. These devises are mainly used to cure back pain through decompression of the spine. But prevention is better than cure.

U.S. Pat. No. 10,195,098 to Gordon Roeder disclosing a spinal decompression harness with a stool to sit, but may not be applicable in regular sitting use for quick ingress and egress. U.S. Pat. No. 7,601,132 to Nichols et al disclosing a traction assembly to a chair. U.S. Pat. No. 5,626,540 to Hall disclosing a support apparatus for the torso of a standing person.

It should be noted that those who suffer from chronic back pain, more than 85% are caused mainly because of prolonged sitting. Therefore, there is a need for a chair for regular usage that can eliminate the compressive forces to the spine and provide a proper posture to the back.

### SUMMARY

In one aspect of the present invention, a chair apparatus is provided. The chair includes a seat, a back rest, a leg rest, and a vertical front support. The leg rest is connected to the seat. The vertical front support rotatably supports the leg rest and seat at or near the junction of the seat and leg rest. The seat is movable from a first position that is in at least close proximity to the back rest to a second position in which a rear portion of the seat is moved down and away from the back rest to a sufficient distance that removes sufficient upward force on a spine of a user to enable spine decompression when the user sits on the seat.

In accordance with one embodiment, a posture correcting chair for reducing the cause of back pain is provided. The chair comprises of a first back rest configured to be adjustable according to person's body type and size. Second support configured to be about 30 degree angle to the vertical plane, which supports the thighs and suspends the buttock without causing any reaction force to the spine.

The key feature of the chair lies in the special seating angle between the hip and back such that the spine is suspended and a good posture is forced upon the occupant.

Another key feature and advantage of the present invention is its ability to transform into a regular chair as and when needed. The person can sit in the regular chair configuration and then may change the seat angle to 30 degrees from the vertical for spinal decompression for extended periods of time while watching TV or working in an office. Then as the need be, the person may change the seat angle back to 90 degrees to the vertical or even more for ease of egress.

Further features and advantages will appear more clearly on a reading of the following detailed description of the preferred embodiments, which is given by way of non-limiting examples only and with reference to the accompanying drawings. The application of this invention applies to chairs in homes, offices, automobiles and any other instances when prolonged seating is required.

### BRIEF DESCRIPTION OF THE DRAWINGS

The present invention will now be described, by way of example with reference to the accompanying drawing figures, in which:

FIG. 1 is a right side view of a person sitting in the chair according to a preferred embodiment of the present invention shown;

FIG. 2 is a right side view of the chair with a particular design details in the intended sitting configuration;

FIG. 3 is a right side view of the chair with a particular design details in the regular chair sitting configuration;

FIG. 4 is a right side view of the chair with a particular design details in the ease of egress configuration;

FIG. 5 is a top perspective view of the chair with particular design details of the seat movement mechanism;

FIG. 6 is a perspective view of the chair with particular design details of the seat back movement mechanism;

FIG. 7 is a cross section view of a portion of the chair that provides the details of the seat back sliding and tilting mechanism;

FIG. 8 is bottom perspective of the leg rest and foot rest illustrating the adjusting mechanism to move the foot rest along the leg rest; and

FIG. 9 is a view similar to that of FIG. 2, but showing an alternative version of the present invention with the leg rest and the seat rotatably connected together.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

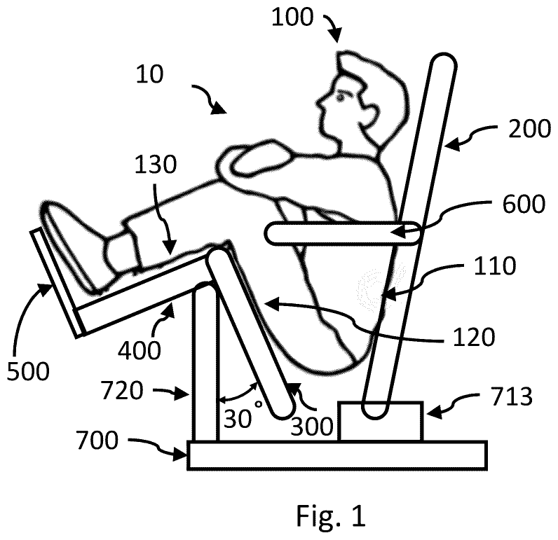

In describing the preferred embodiments of the present invention, as illustrated in FIGS. 1-9, specific terminology is employed for the sake of clarity. The invention, however, is not intended to be limited to the specific terminology so selected, and it is to be understood that each specific elements includes all technical equivalents that operates in a similar manner to accomplish similar functions.

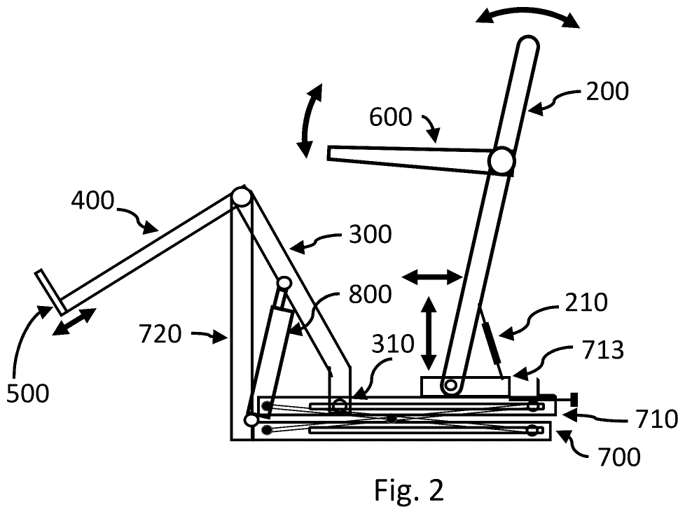

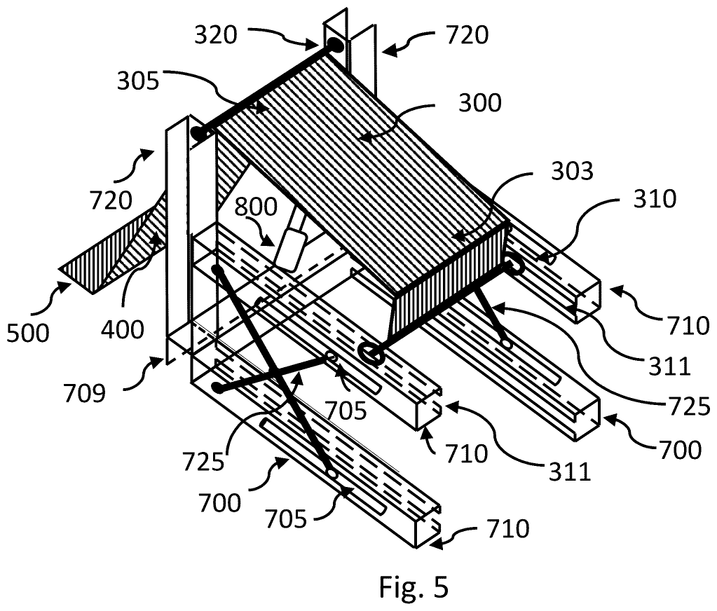

Referring now to FIG. 1, the present invention in one embodiment comprises of a chair apparatus 10 and associated body parts therefore, wherein the occupant 100 with back 110 supported by a back rest 200. The thigh 120 supported with the seat 300, leg 130 supported with leg rest 400, attached to which is the foot rest 500. Back rest 200 is held by a pair of right and left top arms 710 of a scissor lift mechanism 701 as seen in FIGS. 2-5. With reference to FIG. 5, the top arms 710 are movably supported by a pair of right and left lower base arms 700 of a base of the scissors lift mechanism 701. The seat 300 is held by a front base arm 709 that extends between the right and left base arms 700 and is attached to them. The base arms 700, 709 rest upon the ground and are attached to a pair of vertical front support legs 720. The arm rest 600 (FIGS. 1-4) is attached to the back rest 200.

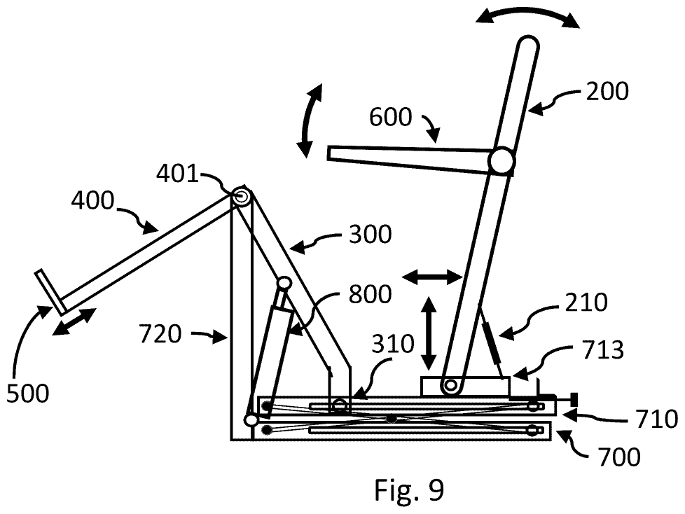

FIG. 2 provides the details of a particular mechanism by which the desired requirements of the invention can be easily achieved. It shows a side view of the chair in its desired seat position of about 30 degrees to the vertical. The seat 300 is pivotally supported by the vertical front support legs 720. The leg rest 400 and the foot rest 500 are an extension of the seat structure. The seat 300 is fixed to the leg rest 400 at about ninety degrees and rotates with the leg rest 400. Alternatively, the seat 300 may be rotatably connected to the leg rest 400 by, for example, a pin 401 as shown in FIG. 9 to enable the leg rest 400 to pivot upon relative to the seat to selective positions. Turning the pin 401 clockwise tightens and locks the leg rest 400 to the seat at the selective position, and turning the pin 401 counterclockwise loosens and unlocks the leg rest 400 against the seat 300 to enable the leg rest 400 to pivot relative to the seat 300. The seat 300 and leg rest 400 are rotatably connected to the vertical front support legs 720 via a pin joint 320 and are able to rotate about the pin joint 320 on the front support legs 720. The seat 300 can rotate up and down about the pin joint 320 with the help of an actuator 800. The actuator 800 may be an electrically operated actuator or any suitable type of actuator such as a pneumatic actuator or hydraulic actuator. The actuator is elongated and has one end attached to the seat 300 and the opposite end attached to the front base arm 709. The actuator 800 may include a switch to actuate and deactuate the actuator 800. The seat back rest 200 is attached to the seat back bottom slide mechanism 713 which is supported by the top arms 710. The seat back bottom slide mechanism 713 can slide back and forth on the top arms 710, which in turn can move up and down with the change of angle of the seat 300.

The arm rest 600 is attached to the seat back rest 200 and is able to rotate up and down as required. The side base arms 700 and top arms 710 form the lower and upper parts of the scissor lift mechanism 701, where the base arms 700, 709 rests on the ground and the top arms 710 are lifted up and down by the movement of the seat to which it is attached through rollers 310. The rollers 310 are received in channels 311 provided in the inner side of the top arms 710 and roll in the forward direction when the seat 300 is moved from the first to the second position.

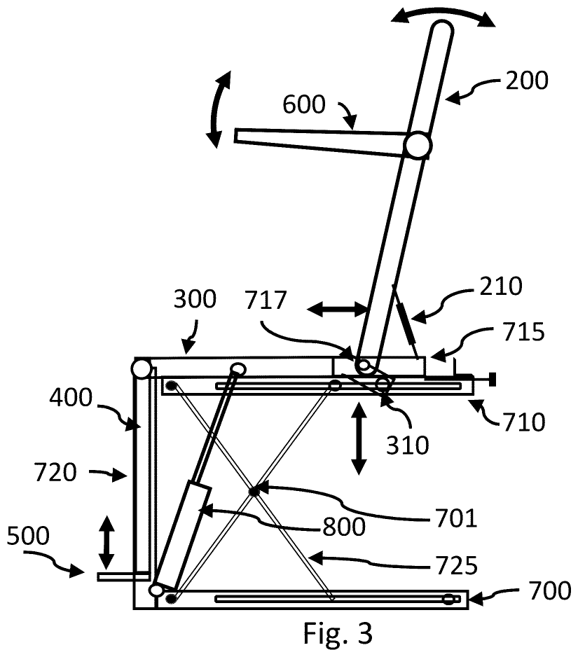

FIG. 3 shows a side view where the seat 300 has been rotated by the actuator 800 upon actuation of the actuator 800 to a normal sitting position. Here the seat 300 is at 90 degrees to the vertical or horizontal position at a first position like a normal chair. An occupant 100 can sit in the chair 10 in this normal position. The occupant 100 can then lower himself to about 30 degrees seat angle to the vertical at a second position of the seat 300 for spine decompression upon deactuating the actuator 800 so that the actuating force to prevent the seat 300 from lowering when the occupant sits on the seat 300 is not being applied to the seat 300. In the second position, a rear portion 303 (FIG. 5) of the seat 300 is lower than a front portion 305 (FIG. 5) of the seat 300. Also, the rollers 310 roll along the channels 311 in the forward direction when the seat 300 is moved from the first position to the second position.

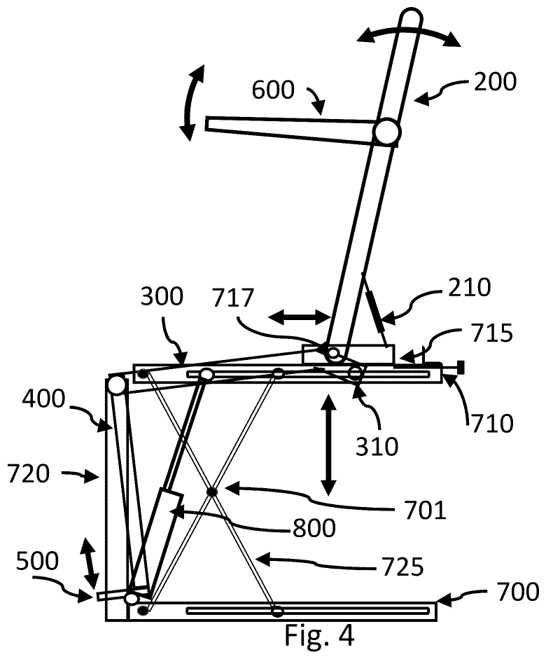

This first position is desired because it may be sometimes difficult for someone to sit directly in this final seating position. FIG. 4 shows a side view where the seat 300 has been rotated by the actuator 800 beyond the horizontal seat position to a third position in which the rear portion 303 of the seat is higher than the front portion 305 such that the occupant can easily slide out of the chair. This seat 300 angle position is sometimes needed for elderly or severe back pain occupants to help easy egress.

FIG. 5 shows a perspective view to detail the seat 300 rotation and scissors lift mechanism 701. Each of the top arms 710 define the C-channel 311 where in the rollers 310 attached to the seat 300, can slide back and forth as the seat 300 is rotated up and down by the actuator 800. The seat 300 is able to rotate about the pin joint 320 on the front support legs 720. The lift mechanism 701 includes right and left pairs of cross link members 725, that define the scissor lift mechanism 701. Each cross link 725 member is rotatably pinned at one end and slidably received at the other end in longitudinal slots 705 formed in the base and top arms 700, 710. Each pair of cross link members 725 are pin connected to each other in their centers as shown to enable rotational movement with respect to each other. Each pair of cross link members 725 may rotate with respect to each other at their centers and slide rearwardly along their respective slots 705 to allow the top arms 710 and hence seat 300 to be lowered from the first horizontal position in which the occupant is at a normal sitting position to the second position in which the seat 300 is at angle of 30 degrees to the vertical. Each pair of cross link members 725 may rotate with respect to each other at their centers and slide forwardly along their respective slots 705 to allow the top arms 710 and hence seat 300 to be raised from the first horizontal position in which the occupant is at a normal sitting position to the third position for ease of egress.

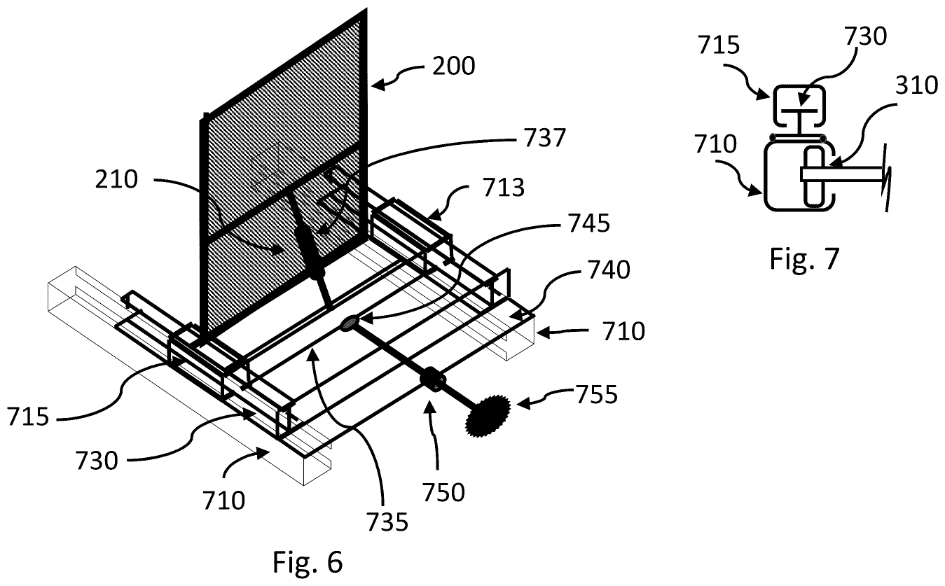

FIG. 6 shows a perspective view to detail the seat back rest 200 attachment and its slide mechanism 713, to rotate and slide for different occupant size fit, and FIG. 7 provides the details of the seat back sliding mechanism in a cross section view. I-section rails or members 730 are attached to their respective top arms 710. Each I-section member 730 slidingly receives a C-section channel member 715 and slides back and forth on member 730, positioned as desired by the screw 755. The screw 755 passes through the screw nut 750 attached to the L-section member 740 fixed to the top support arms 710, and connects to the pin joint 745 attached to the L-section 735 fixed to the sliding C-section channel member 715. The seat back rest 200 rotation is achieved by changing the length of the adjustable length member 210. Specifically, the back rest 200 is pivotally connected at its bottom end to the sliding C-section channel member 715 via a pin 717. The member 210 is attached at one end to the back rest 200 and the other end to the L-section member 735. The member 210 includes an elongated nut 737. Rotating the elongated nut 737 adjusts the length of the member 210 which causes the back rest 200 to pivot at selected angles of the back rest relative the L-section member 735.

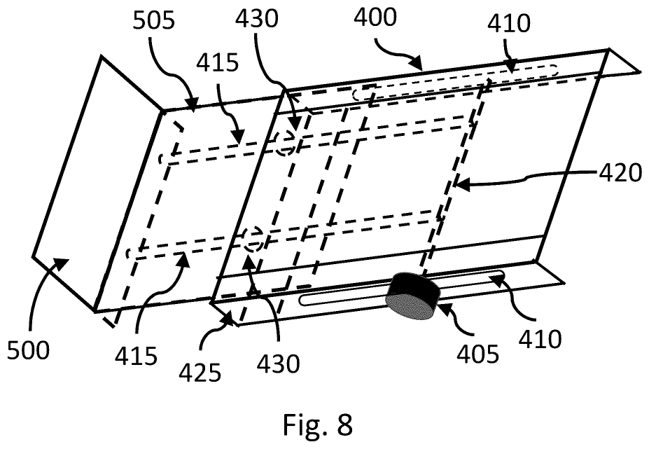

Referring to FIG. 8, the foot rest 500 may be slidably connected to the leg rest 400 to enable the foot rest 500 to slide along the leg rest 400 at selected positions. This allows the foot rest 500 to be raised and lowered at various heights from the ground. Specifically, a sliding cover 505 is attached to the foot rest 500 and extends upwardly along the leg rest 400. A pair of longitudinal guide rod members 415 are positioned under the sliding cover 505 and are attached to the foot rest 500. The leg rest 400 includes side angle members 425 attached on opposite longitudinal ends of the leg rest 400 and a front angle member 425 positioned between the side angle members 425 and attached to them. A longitudinal guide rod slot 410 is formed in each of the side angle members 425. A locking rod 420 extends across and through the sliding cover 505 and through the guide slots 410. A knob 405 is threadily connected via a pin on one of the ends of the locking rod 420 and is positioned outside a guide slot 410. The knob 405 has a diameter that is larger than the width of the guide slot 410 adjacent to the knob 405. A pair of longitudinally oriented apertures 430 are formed in the front angle member 425 and receive the guide rods 410.

In operation, a user grasps the knob 405 turns it counterclockwise to loosen the knob 405 against the adjacent side angle member 425 enough to allow the user to move the locking rod 420 and hence the sliding cover 505 and foot rest 500 back and forth along the guide slots 410. When the user desires to lock the foot rest 500 at a desired position, the user turns the knob 405 clockwise to tighten the knob 405 against the adjacent the side angle member 425 and lock the sliding cover 505 and foot rest 500 to the leg rest 400 at that position. When a user wants to move the foot rest 500 to a different position, the user turn the knob 405 counterclockwise to loosen it from the adjacent side angle member 425 and unlock the sliding cover 505 from the leg rest 400 to enable the user to move the sliding cover 505 and foot rest 500 along the guide slot 410 to another desired position.

Thus, the present invention is directed to a spinal decompression and spine reaction force elimination chair designed to help reduce one of the leading causes of human back pain. When seated on a regular chair, the pelvic basin generates reaction force which in turn compresses the spine and may result in the deformation or failure of the vertebral body and vertebral disc compression over time, leading to spinal stenosis causing back pain. The sitting configuration in the disclosed chair prevents back pain from occurring and also relieves back pain when present. The present invention also forces a good sitting posture for the torso thus prevents slouching. Pain from stenosis is reduced when correct posture lowers abnormal pressure on the spinal cord and the nerve roots.

The foregoing description and drawings comprise illustrative embodiments of the present invention. Having thus described the exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains, having the benefit of the teachings presented in the foregoing descriptions and the associated drawings. Although specific terms may be employed herein, they are used in a generic and descriptive sense only and not for the purposes of limitation. Accordingly, the present invention is not limited to the specific embodiments illustrated herein, but is limited only by the following claims.

What is claimed is:

1. A chair apparatus comprising:
a seat;
a back rest;
a leg rest, wherein the leg rest is connected to the seat;
a vertical front support, wherein the vertical front support rotatably supports the leg rest and seat at or near the junction of the seat and leg rest, wherein the seat is movable from a first position that is in at least close proximity to the back rest to a second position in which a rear portion of the seat is moved down and away from the back rest to a sufficient distance that removes sufficient upward force on a spine of a user to enable spine decompression when the user sits on the seat.

2. The chair apparatus of claim 1, further comprising:
an actuator, wherein the actuator is in operative connection with the seat, wherein the actuator is operative to enable the seat to move from the first position to the second position, wherein the actuator is operative to move the seat from the second position to the first position.

3. The chair apparatus of claim 2, wherein the actuator is an elongated actuator, wherein actuator has one axial end connected to the seat and the other axial end connected to a base.

4. The chair apparatus of claim 2, further comprising a scissor lift mechanism, wherein the seat is supported by the scissor lift mechanism, wherein the scissor lift mechanism is operative to enable the seat to move between the first and second positions.

5. The chair apparatus if claim 4, wherein the scissor lift mechanism comprises:
first and second top arms, wherein the first and second top arms support the seat;
first and second lower base arms; and
first and second pairs of cross link members, wherein the cross link members in each pair are rotatably connected to each other at their centers, wherein a first cross link member of the first pair has one axial end rotatably connected to the first top arm and the other axial end slidably received in a first slot of the first base arm, wherein a second cross link member of the first pair has one axial end rotatably connected to the first base arm and the other axial end slidably received in a second slot of the first top arm, wherein the first and second cross link members rotate with respect to each other at their centers and slide rearwardly along their respective first and second slots to allow the first and second top arms and the seat to be lowered from the first position to the second position.

6. The chair apparatus of claim 1, wherein the seat is moveable down and away from the back rest to at least an angle of thirty degrees to the vertical in the second position.

7. The chair apparatus of claim 1, wherein the seat is moveable to a third position in which the rear portion of the seat is higher than a front portion of the seat to enable the user slide out of the seat.

8. The chair apparatus of claim 1, further comprising:
a scissor lift mechanism, wherein the seat is supported by the scissor lift mechanism, wherein the scissor lift mechanism is operative to enable the seat to move between the first and second positions, wherein the scissor lift mechanism comprises first and second top arms, wherein the first and second top arms support the seat; and
a slide mechanism, wherein the back rest is connected to the slide mechanism, wherein the slide mechanism is position upon the first and second top arms and is configured to slide back and forth along the first and second top arms to move the back rest at selected distances along the first and second arms.

9. The chair apparatus of claim 8, further comprising rails attached on the first and second arms, wherein the slide mechanism slidingly receives the rails.

10. The chair apparatus of claim 8 further comprising a screw and nut, wherein the screw pass through the nut and is fixed to the slide mechanism, wherein rotation of the screw moves the back rest at selected distances along the first and second arms.

11. The chair apparatus of claim 8, further comprising an adjustable length member, wherein the back rest is pivotally connected to the slide mechanism, wherein the adjustable length member is operatively connected to the back rest and the slide mechanism, wherein the adjustable length member is operative to pivot the back rest at selected angles of the back rest relative to the slide mechanism.

12. The chair apparatus of claim 8 further comprising:
a foot rest, wherein the foot rest is movably attached to the leg rest, wherein the foot rest is operative to move along the leg rest at selected positions;
a sliding cover, wherein the sliding cover is attached to the foot rest and extends along the leg rest;
a lock rod, wherein the lock rod extends through the sliding cover and guide slots of the leg rest to enable the lock rod, the sliding cover and the foot rest to move back and forth along the guide slots; and
a knob, wherein the knob is operatively connected to the lock rod, wherein the knob is operative to lock the lock rod against the leg rest.

13. The chair apparatus of claim 1, further comprising:
an actuator, wherein the actuator is in operative connection with the seat, wherein the actuator is operative to enable the seat to move from the first position to the second position, wherein the actuator is operative to move the seat from the second position to the first position, wherein the actuator is an elongated actuator, wherein actuator has one axial end connected to the seat and the other axial end connected to a base.

14. The chair apparatus of claim 1 further comprising a foot rest attached to the leg rest.

15. The chair apparatus of claim 1 further comprising an arm rest pivotally connected to the back rest.

16. The chair apparatus of claim 1 further comprising a foot rest, wherein the foot rest is movably attached to the leg rest, wherein the foot rest is operative to move along the leg rest at selected positions.

17. The chair apparatus of claim 16 further comprising:
a sliding cover, wherein the sliding cover is attached to the foot rest and extends along the leg rest;
a lock rod, wherein the lock rod extends through the sliding cover and guide slots of the leg rest to enable the lock rod, the sliding cover and the foot rest to move back and forth along the guide slots; and
a knob, wherein the knob is operatively connected to the lock rod, wherein the knob is operative to lock the lock rod against the leg rest.

18. The chair apparatus of claim 1, wherein the leg rest is rotatably connected to the seat and is configured to pivot relative to the seat at selected positions.

19. The chair apparatus of claim 1 wherein the seat is moveable down and away from the back rest to at an angle of thirty degrees or less to the vertical in the second position.

20. The chair apparatus of claim 1 wherein the seat is moveable down and away from the back rest to at an angle between fifteen and forty five degrees to the vertical in the second position
